(19) United States
(12) Patent Application Publication
(10) Pub. No.: US 2008/0145552 A1
(43) Pub. Date: Jun. 19, 2008

(54) Fluorochemical and polyoxyalkylene siloxane additive for coatings

(76) Inventors: Mia Genevieve Berrettini, Wilmington, DE (US); Axel Hans-Joachim Herzog, West Chester, PA (US); John Gavenonis, Wilmington, DE (US); Donald Douglas May, Chadds Ford, PA (US); Xianjun Meng, Hockessin, DE (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/899,238

(22) Filed: Sep. 5, 2007

Related U.S. Application Data
(60) Provisional application No. 60/875,136, filed on Dec. 15, 2006.

(51) Int. Cl. B05D 3/00; C08K 5/5419

(52) U.S. Cl. 427/444; 524/139; 524/267

(57) ABSTRACT

Coating compositions comprise a coating base, a polyoxyalkylene siloxane additive and a fluorochemical wherein the polyoxyalkylene siloxane is of Formulae 1A, 1B, 1C, or 2:

(R²)₃SiO[Si(R²)₂O]_{y}[Si(R²)(R¹)O]ₓ[Si(R²)₂O]_{z}Si(R²)₃Formula 1A

(R²)₃SiO[Si(R²)₂O]ₓ[Si(R²)₂R¹Formula 1B

R¹(R²)₂SiO[Si(R²)₂O]ₓ[Si(R²)₂O]Si(R²)₂R¹Formula 1C

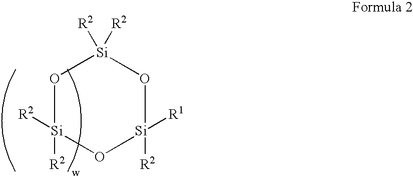

wherein
each R² is independently H, alkyl, or aryl;
each R¹ is a polyoxyalkylene group having the formula 3 as follows:

—CₙR⁴ₚH₂ₙ₋ₚQCₘR⁵ₚH₂ₘ₋ₚOZR³Formula 3

wherein
each R⁴ and R⁵ is independently H, alkyl, or aryl;
Q is CₙHR⁴, aryl, CH₂CH(OR⁴), CH₂(CH₂OR⁴), S, O, SO, SO₂, SO₂NR⁴, OC(O), OC(NR⁴), NHC(X)NH, or OC(X)NH or triazole;
Z is [C₂H₄O]ₐ and [C₃H₆O]_{b} in block or random order;
X is O or S;
m and n are each independently an integer of 2 to 8;
a is an integer of 0 to about 30; b is an integer of 0 to about 20; provided that a+b is from 1 to about 50;
each R³ is independently H, acyl, CH₃, or a linear or branched alkyl or aryl group having 1 to about 20 carbon atoms;
w is an integer of from 1 to 3;
x is an integer of from 1 to about 20;
y is an integer of from 0 to about 20; and
z is an integer of from 0 to about 10;
   and the fluorochemical is selected from the group consisting of a perfluoroalkyl ester, fluorinated urethane, fluoroalkyl phosphate or salt thereof, fluoroalkyl phosphate ester or salt thereof, a mixture of a fluoroalkyl phosphate and a glycol ester, and fluoroalkylpolyoxyethylene.

### FIELD OF THE INVENTION

This invention relates to coating compositions comprising polyoxyalkylene siloxane additives, and fluorochemicals, providing durable improved surface effects during application and in the dried coatings.

### BACKGROUND OF THE INVENTION

Conventional coating compositions of interest in the present invention are paints, clear coatings, stains, and similar known compositions. Examples include alkyd coating compositions, urethane coating compositions, water-dispersible coating compositions, and unsaturated polyester coating compositions. The coating compositions are described in Outlines of Paint Technology (Halstead Press, New York, N.Y., Third edition, 1990) and Surface Coatings Vol. I, Raw Materials and Their Usage (Chapman and Hall, New York, N.Y., Second Edition, 1984). All of the above-listed conventional coating compositions after drying or curing often show low hexadecane contact angles, are readily wetted by oil, and are susceptible to soiling. The resulting dried film produced from the above described compositions is also often less than desirably uniform. The non-uniformity of such a cured surface coating causes the contact angle measurement to be low. Contact angle is known to reflect the ability of such a cured surface to be readily cleaned.

U.S. Pat. No. 5,859,126 discloses coating compositions containing certain esters of an unsaturated acid and fluorinated alcohol providing oil repellency and water repellency in the dried coating. U.S. Pat. No. 5,827,919 discloses fluorourethane additives for water-dispersed coating compositions which provide soil resistance, oil repellency and cleanability in the dried coating. Such additives are costly due to the high level of fluorine employed. U.S. Pat. No. 5,558,806 teaches the use of a blend of polyalkyleneoxide polysiloxane and a hydrocarbon compound for use in pesticide applications. The '806 patent does not teach the use of polyalkyleneoxide polysiloxane in combination with fluorocarbon surfactants for the lowering of the surface tension of aqueous solutions.

It is desirable to improve particular surface effects of coating compositions and the durability of such surface effects. In particular it is desirable to improve such surface effects by use of multiple additives to achieve the improved performance. The present invention provides such compositions.

### SUMMARY OF THE INVENTION

The present invention comprises a coating composition comprising a coating base, a polyoxyalkylene siloxane additive, and a fluorochemical.

The present invention further comprises a dried coating of the above compositions.

The present invention further comprises a method of providing durable cleanability to a surface having deposited thereon a dry coating composition comprising addition to the coating composition prior to drying of a polyoxyalkylene siloxane and a fluorochemical selected from the group consisting of 1) fluorinated urethane, 2) fluoroalkyl phosphate and salt thereof, 3) fluoroalkyl phosphate ester and salt thereof, 4) a mixture of a fluoroalkyl phosphate and a glycol ester, and 5) fluoroalkylpolyoxyethylene.

The present invention further comprises a method of providing durable oil repellency and soil resistance to a surface having deposited thereon a dry coating composition comprising addition to the coating composition prior to drying of a polyoxyalkylene siloxane and a fluorochemical selected from the group consisting of a perfluoroalkyl ester, fluorinated urethane, fluoroalkyl phosphate or salt thereof, fluoroalkyl phosphate ester and salt thereof, and fluoroalkylpolyoxyethylene.

The present invention further comprises a method of providing resistance to blocking to a surface having deposited thereon a dry coating composition comprising addition to the coating composition prior to drying of a polyoxyalkylene siloxane and a fluorochemical selected from the group consisting of 1) fluoroalkyl phosphate and salt thereof, 2) fluoroalkyl phosphate ester and salt thereof, 3) a mixture of a fluoroalkyl phosphate and a glycol ester, and 4) fluoroalkylpolyoxyethylene.

The present invention further comprises a method of providing open time extension, wetting and leveling to a coating during application of the coating to the surface comprising addition to the coating composition prior to application of a polyoxyalkylene siloxane and a fluorochemical selected from the group consisting of a perfluoroalkyl ester, fluorinated urethane, fluoroalkyl phosphate or salt thereof, fluoroalkyl phosphate ester and salt thereof, and fluoroalkylpolyoxyethylene.

Coating compositions comprising a polyoxyalkylene siloxane additive and a fluorochemical as described herein generally result in improved surface properties of such compositions relative to the compositions that do not contain either component or comprise either component alone.

### BRIEF DESCRIPTION OF THE FIGURES

FIG. 1 is a graph of surface tension vs. active ingredient (amount by weight based on percent solids) of Fluorochemical 2 denoted as FC2, Polyoxyethylene siloxane 1 denoted as PS1, and various combinations thereof.

FIG. 2 is a graph of surface tension vs. active ingredient (amount by weight based on percent solids) of Fluorochemical 3 denoted as FC3, Polyoxyethylene siloxane 1 denoted as PS1, and various combinations thereof.

### DETAILED DESCRIPTION OF THE INVENTION

Trademarks are indicated hereby by capitalization.

The present invention comprises a coating composition comprising a coating base, a polyoxyalkylene siloxane additive, and a fluorochemical. The coating base is any of a variety of a typical conventional paint, coating or stain bases, which may contain one or more fluorochemicals. A polyoxyalkylene siloxane and optional fluorochemical are added to the coating base to provide the composition of the present invention.

By the term “alkyd coating” as used herein is meant a conventional liquid coating based on alkyd resins, typically a paint, clear coating, or stain. The alkyd resins are complex branched and cross-linked polyesters containing unsaturated aliphatic acid residues. Conventional alkyd coatings utilize, as the binder or film-forming component, a curing or drying alkyd resin. Alkyd resin coatings contain unsaturated aliphatic acid residues derived from drying oils. These resins spontaneously polymerize in the presence of oxygen or air to yield a solid protective film. The polymerization is termed “drying” or “curing” and occurs as a result of autoxidation of the unsaturated carbon-carbon bonds in the aliphatic acid component of the oil by atmospheric oxygen. When applied to a surface as a thin liquid layer of formulated alkyd coating, the cured films that form are relatively hard, non-melting, and substantially insoluble in many organic solvents that act as solvents or thinners for the unoxidized alkyd resin or drying oil. Such drying oils have been used as raw materials for oil-based coatings and are described in the literature.

By the term “urethane coating” as used hereinafter is meant a conventional liquid coating based on Type I urethane resins, typically a paint, clear coating, or stain. Urethane coatings typically contain the reaction product of a polyisocyanate, usually toluene diisocyanate, and a polyhydric alcohol ester of drying oil acids. Urethane coatings are classified by ASTM D-1 into five categories. Type I urethane coatings contain a pre-reacted autoxidizable binder as described in Surface Coatings Vol. I, previously cited. These are also known as uralkyds, urethane-modified alkyds, oil-modified urethanes, urethane oils, or urethane alkyds, are the largest volume category of polyurethane coatings and include paints, clear coatings, or stains. The cured coating is formed by air oxidation and polymerization of the unsaturated drying oil residue in the binder.

By the term “unsaturated polyester coating” as used hereinafter is meant a conventional liquid coating based on unsaturated polyester resins, dissolved in monomers and containing initiators and catalysts as needed, typically as a paint, clear coating, or gel coat formulation.

Unsaturated polyester resins contain as the unsaturated prepolymer the product obtained from the condensation polymerization of a glycol such as 1,2-propylene glycol or 1,3-butylene glycol with an unsaturated acid such as maleic (or of maleic and a saturated acid, e.g., phthalic) in the anhydride form. The unsaturated prepolymer is a linear polymer containing unsaturation in the chain. This is dissolved in a suitable monomer, for instance styrene, to produce the final resin. The film is produced by copolymerization of the linear polymer and monomer by means of a free radical mechanism. The free radicals can be generated by heat, or more usually by addition of a peroxide, such as benzoyl peroxide, separately packaged and added before use. Such coating compositions are frequently termed “gel coat” finishes. In order that curing can take place at room temperature, the decomposition of peroxides into free radicals is catalyzed by certain metal ions, usually cobalt. The solutions of peroxide and cobalt compound are added separately to the mix and well stirred before application. The unsaturated polyester resins that cure by a free radical mechanism are also suited to irradiation curing using, for instance, ultraviolet light. This form of cure, in which no heat is produced, is particularly suited to films on wood or board. Other radiation sources, for instance electron-beam curing, are also used.

By the term “water-dispersed coatings” as used herein is meant coatings intended for the decoration or protection of a substrate composed of water as an essential dispersing component such as an emulsion, latex, or suspension of a film-forming material dispersed in an aqueous phase. “Water-dispersed coating” is a general classification that describes a number of formulations and includes members of the above described classifications as well as members of other classifications. Water-dispersed coatings generally contain other common coating ingredients. Water-dispersed coatings are exemplified by, but not limited to, pigmented coatings such as latex paints, unpigmented coatings such as wood sealers, stains, and finishes, coatings for masonry and cement, and water-based asphalt emulsions. A water dispersed coating optionally contains surfactants, protective colloids and thickeners, pigments and extender pigments, preservatives, fungicides, freeze-thaw stabilizers, antifoam agents, agents to control pH, coalescing aids, and other ingredients. For latex paints the film forming material is a latex polymer of acrylate acrylic, vinyl-acrylic, vinyl, or a mixture thereof. Such water-dispersed coating compositions are described by C. R. Martens in “Emulsion and Water-Soluble Paints and Coatings” (Reinhold Publishing Corporation, New York, N.Y., 1965).

By the term “coating base” as used herein is meant a composition, typically a liquid formulation, of an alkyd coating, Type I urethane coating, unsaturated polyester coating, or water-dispersed coating, and is applied to a substrate for the purpose of creating a lasting film on the substrate surface.

By the term “dried coating” as used herein is meant the final decorative and/or protective film obtained after the coating composition has dried, set or cured. Such a final film can be achieved by, for non-limiting example, curing, coalescing, polymerizing, interpenetrating, radiation curing, ultraviolet (UV) curing or evaporation. Final films can also be applied in a dry and final state as in dry coating.

By the term “radiation curing” as used herein is meant the production of a dried coating wherein during the drying process a coating composition is exposed to radiation of any wavelength to cause radiation-initiated bond formation. Said bonding processes include but are not limited to cross-linking, polymerization, coalescence, and free radial formation.

By the term “UV curing” as used herein it is meant radiation curing wherein the radiation substantially consisting of wavelengths in the ultra-violet spectrum. Ultraviolet radiation typically is defined as wavelengths between about 1 and about 400 nanometers in length. Preferably, UV curing utilizes wavelengths between about 200 nm and about 380 nm.

By the term “polyoxyalkylene siloxane additive” as used herein is meant a component of a coating composition, which can be added to a coating base, and is composed significantly of polyoxyalkylene siloxane.

By the term “fluorochemical” as used herein is meant an element, compound, polymer, or composition that contains fluorine and is a component of a coating composition, or which are added to a coating base. The fluorochemicals are inherent fluorochemicals in a coating composition that interact with additional additives, or are themselves additives to a coating composition. The amount of fluorochemical in a coating composition is measured by the microgram amount of elemental fluorine present per gram of total weight.

By the term “improved cleanability” as used herein is meant that a coating composition containing an additive demonstrates an improvement in cleaning performance when compared to the same or a substantially similar coating composition that does not contain said additive. Such improvement is preferably evaluated by the Leneta oil stain test for cleanability as described herein.

By the term “open time extension” as used herein is meant the time during which a layer of liquid coating composition can be blended into an adjacent layer of liquid coating composition without showing a lap mark, brush mark, or other application mark. It is also called wet-edge time. Low volatile organic compound, hereinafter VOC, latex paint has shorter than desired open-time due to lack of high boiling temperature VOC solvents. Lack of open time extension will cause surface defects such as overlapping brush marks or other marks. Open time extension is one of the properties that need improvement in low VOC coating formulations.

By the term “blocking” as used herein is meant the undesired sticking together of two coated surfaces when pressed together or placed in contact with each other for an extended period of time.

The coating compositions of the present invention are useful for providing a protective and/or decorative coating to a wide variety of substrates. Such substrates include primarily construction materials and hard surfaces such as wood, metal, wallboard, masonry, concrete, fiberboard, paper, and other materials. Upon application, such coating compositions dry or cure by conventional methods and the dried coatings of the present invention exhibit several valuable properties. Specifically, the dried coatings of this invention, compared with conventional dried coatings, exhibit improved oil repellency, cleanability, resistance to blocking, open time extension, soil resistance on exterior substrates, and wetting and leveling.

The contact angle formed between a surface and a drop of liquid is a measure of the wettability or repellency of the surface to the liquid. A wettable surface has low contact angles close to zero degrees. A repellent surface has higher contact angles. Thus, the contact angle formed by an oily liquid such as hexadecane is widely used as a measure of the oil repellency of a surface. In general, higher hexadecane contact angles indicate that a surface has greater dirt and stain repellency, and easier cleanability. The advancing water contact angle is indicative of water sheeting ability. Decreased water contact angle correlates with increased sheeting ability, and thus increased ability for soil to be washed away from a surface by rain or other water running across the surface.

When the present invention is practiced as described herein, the result is a chemically stable, dried coating surface that provides durability of the improved cleanability and the improved oil repellency. Typically the dried coating resulting from a base coating to which has been added a polyoxyalkylene siloxane additive and fluorochemical increases the advancing hexadecane contact angle. The dried coating resulting from a composition containing such additives increases cleanability of the coated surface as demonstrated by the Leneta oil test when compared to a coating lacking the polyoxyalkylene siloxane and fluorochemical additives. By durable improved cleanability, durable oil repellency, and durable increased hexadecane contact angles are meant that the advantageous surface properties of the dried coatings of the present invention are retained following various simulations of repeated surface cleaning. Thus the oil repellency and cleanability are retained after conventional washing of the surface. The dried coatings of the present invention also demonstrate improved resistance to blocking, open time extension, soil resistance, and wetting and leveling compared to coating compositions that do not contain a polyoxyalkylene siloxane additive and fluorochemical.

The polyoxyalkylene siloxane additive suitable for use in the present invention is defined by the general formulae 1A, 1B, 1C, or 2 as follows:

(R²)₃SiO[Si(R²)₂O]Y[Si(R²)(R¹)O]ₓ[Si(R²)₂O]_{z}Si(R²)₃ Formula 1A

(R²)₃SiO[Si(R²)₂O]ₓSi(R²)₂R¹ Formula 1B

R¹(R²)₂SiO[Si(R²)₂O]ₓSi(R²)₂R¹ Formula 1C

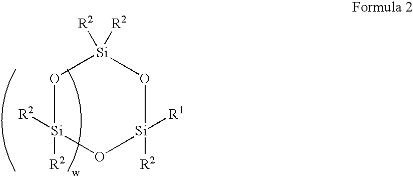

wherein

each R² is independently H, alkyl, or aryl;

each R¹ is a polyoxyalkylene group having the formula 3 as follows:

—CₙR⁴ₚH₂ₙ₋ₚQCₘR⁵ₚH₂ₘ₋ₚOZR³ Formula 3

wherein

each R⁴ and R⁵ is independently H, alkyl, or aryl;

Q is CₙHR⁴, aryl, CH₂CH(OR⁴), CH₂(CH₂OR⁴), S, O, SO, SO₂, SO₂NR⁴, OC(O), OC(NR⁴), NHC(X) NH, or OC(X) NH or triazole;

Z is [C₂H₄O]ₐ and [C₃H₆O]_{b} in block or random order;

X is O or S;

m and n are each independently an integer of 2 to 8;

a is an integer of 0 to about 30; b is an integer of 0 to about 20; provided that a+b is from 1 to about 50;

each R³ is independently H, acyl, CH₃, or a linear or branched alkyl or aryl group having 1 to about 20 carbon atoms;

w is an integer of 1 to 3;

x is an integer of from 1 to about 20;

y is an integer of from 0 to about 20; and

z is an integer of from 0 to about 10.

Preferably R² is H, CH₃, C₂H₅, or C₆H₅; more preferably H or CH₃; and most preferably CH₃.

Many of these polyoxyalkylene siloxane additives are commercially available.

The compounds of Formula 1A, 1B, 1C, and 2 are prepared as follows. The Q-containing species are synthesized according to common published procedures. A summary of these organic transformation reactions can be found in “Comprehensive Organic Transformations” by Richard C. Larock, Wiley-VCH, New York, N.Y., 2^{nd} Edition, 1999.

Generally the attachment of ω-functionalized alkyl groups to the siloxane is accomplished via hydrosilylation of the corresponding ω-functionalized olefin with a silane moiety containing siloxane. In parallel, the polyoxyalkylenes are terminated with ω-functionalized alkylenes via the reaction of the polyoxyalkylene alkoxides with ω-functionalized α-halides and tosylates, respectively, via nucleophilic substitution reactions. If ω-functionalized alkylenes are pre-reacted with ω-functionalized alpha-halides and tosylates, respectively, via their ω-positioned functions, the resulting α-halides/tosylates-ω-olefine intermediates can be reacted further with the polyoxyalkylene alkoxides and, in turn, the desired siloxane surfactant is obtained upon hydrosilylation of the olefin terminated Q-containing polyoxyalkylene species with a silane containing siloxane. Specifically, CₙHR⁴ and arylene containing linker are obtained using the corresponding olefins terminated polyalkyleneoxide precursors.

Derivatives containing CH₂CH(OR⁴) and CH₂(CH₂OR⁴) are furnished by reaction of a glycidyl terminated polyalkylene glycols with ω-hydroxylalkyl substituted siloxanes or glycidyl terminated siloxane with ω-hydroxylalkyl substituted polyalkylene glycols under acid and basic reaction conditions, respectively, optionally followed by alkylation.

Thioethers are generated either by nucleophilic replacement reactions of thiols with halides and tosylates, respectively. Subsequently, sulfur oxides and sulfones are derived from these thioethers by oxidation. Sulfonamides are accessible from the reaction of sulfonyl chlorides with amines.

Acid ester and acid amid linkages are formed by reacting alcohols and amines, respectively, with activated acid derivatives. Alternatively, esters with short alkyl groups can be employer in transeterification and transamidation reactions. Lastly, condensation of acids with alcohols is feasible. Reactions of isocyanates and isothiocyantes, respectively, with amines and alcohols lead to ureas and thioureas, respectively, as well as urethanes and thiourethanes, respectively. The triazoles can be derived by the copper(I)-mediated reaction of an azide with an alkyne.

The coating compositions of this invention contain sufficient polyoxyalkylene siloxane additive such that the coating composition contains, by weight of the content of the composition, from about 0.01% to about 10.0% polyoxyalkylene siloxane additive, or preferably from about 0.01% to about 5.0%, or more preferably from about 0.1 to about 5.0% polyoxyalkylene siloxane additive, or most preferably from about 0.1 to about 1.0% polyoxyalkylene siloxane additive. Most preferred for cleanability is from about 0.1% to about 0.3% by weight polyoxyalkylene siloxane additive. Most preferred for resistance to blocking is from about 0.01% to about 0.3% by weight polyoxyalkylene siloxane additive.

The polyoxyalkylene siloxane additives are effectively introduced to the coating base by thoroughly stirring polyoxyalkylene siloxane into the coating base at room temperature. More elaborate mixing can be employed such as using a mechanical shaker or providing heat or other methods. Such methods are not necessary and do not substantially improve the final composition. The fluorochemicals, when used in combination with the polyoxyalkylene siloxane in the coating composition of the present invention, are also adequately introduced by thorough stirring but may also be present as fluorine sources already in the coating base. Likewise, more elaborate methods of combining the fluorochemical with the coating base can also be used with success but are not necessary and do not substantially improve the final composition. Generally, the manufacturer's directions should be followed to correctly introduce the fluorochemical. The polyoxyalkylene siloxane additive and the fluorochemical can be introduced at the same time or in any sequence with no detriment to the final product.

A wide variety of fluorochemicals are suitable for use in the coating composition of the present invention. These include various perfluoroalkyl esters, fluorinated polyurethanes, and fluoroalkyl phosphates and salts and esters thereof. Many such fluorochemicals are commercially available from E.I. du Pont de Nemours and Company, Wilmington, Del.

Esters containing perfluoroalkyl groups suitable for use in the present invention include an ester of an unsaturated acid and a fluorinated alcohol or thiol of Formula 4a, 4b, or 5 as follows:

R_{f}—X-A-OC—R, Formula 4a

R_{f}X-A-OC—R_{X}—CO-A-X—R_{f}, Formula 4b

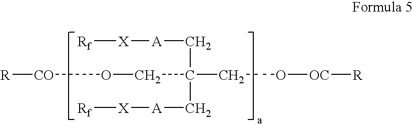

wherein:

R_{f} is a C₁-C₂₀ perfluoroalkyl radical or a C₅-C₃₈ perfluoroalkyl radical containing at least one ether oxygen atom;

R is a C₃-C₂₄ saturated, monounsaturated, or polyunsaturated aliphatic hydrocarbon radical, a C₈-C₁₃ aryl radical having at least one non-aromatic double bond, or mixtures thereof;

X is independently —(CH₂)ₘ—, —CON(R₁)R₂—, —SO₂N(R₁)R₂—, or —(OCH₂CHR₃)_{b}O—, wherein m is 1 to about 20; b is 3 to about 15;

R₁ is H or an alkyl radical of 1 to about 4 carbon atoms, R₂ is C₁-C₁₂ alkylene, and R₃ is H or CH₂Cl;

A is O or S;

R_{X} is a divalent C₃-C₂₂ unsaturated aliphatic hydrocarbon radical, a divalent C₈-C₁₃ aryl radical having at least one non-aromatic double bond, or mixtures thereof; and

a is 1 or 2.

The fluorinated esters of unsaturated carboxylic acids are prepared by conventional processes including direct esterification of unsaturated acids with the fluorinated alcohol or thiol, or tranesterification between the fluorinated alcohol or thiol and esters of the unsaturated acids. The degree of incorporation of the fluorinated alcohol or thiol can be maximized by using a molar excess of the unsaturated acid during esterification or of the unsaturated ester during transesterification. The required unsaturated acids and a number of fluorinated alcohols are commercially available. Such esters and their preparation are further detailed in U.S. Pat. Nos. 5,859,126 and 5,637,657, which is incorporated in its entirety by reference.

Fluorochemical polyurethanes suitable for use in the present invention include a polyfluorourethane compound which is the product of the reaction of (1) at least one diisocyanate, polyisocyanate, or mixture of polyisocyanates containing at least three isocyanate groups per molecule, (2) at least one fluorochemical compound containing at least one Zerewitinoff hydrogen in an amount sufficient to react with 5% to 80% of the isocyanate groups in the diisocyanate or polyisocyanate, (3) at least one compound of the formula R₁₀—(R₂)ₖ—YH in an amount sufficient to react with 5% to 80% of the isocyanate groups in the diisocyanate or polyisocyanate and wherein R₁₀ is a C₁-C₁₈ alkyl, C₁-C₁₈ omega-alkenyl radical, or C₁-C₁₈ omega-alkenoyl; R₂ is —CₙH₂ₙ— optionally end-capped by —[OCH₂C(R₄)H]ₚ—, —[OCH₂C(CH₂Cl)H]ₚ—, or —C(R₅)(R₆)(OCH₂C[CH₂Cl]H)ₚ— wherein R₄, R₅, and R₆ are the same or different and are H or a C₁-C₆ alkyl radical, n is 0 to 12, p is 1 to 50; Y is O, S, or N(R₇) wherein R₇ is H or C₁-C₆ alkyl; and k is 0 or 1, and (4) water in an amount sufficient to react with 5% to 60% of the isocyanate groups in the diisocyanate or polyisocyanate.

A Zerewitinoff hydrogen is an active hydrogen which will react with a methyl magnesium halide (Grignard reagent) to liberate methane. Examples include the hydrogens in —OH or —COOH or in a primary amine. Volumetric measurement of the methane permits quantification of the active hydrogen content of a compound. For purposes of this invention it is assumed that primary amines provide one active hydrogen as defined by Zerewitinoff et al. (Zerevitinov, Th., Quantitative Determination of the Active Hydrogen in Organic Compounds, Berichte der Deutschen Chemischen Gesellschaft (1908) 41, 2733-43.) A Zerewitinoff hydrogen reacts with an isocyanate group to form a urethane. Examples of suitable fluorochemical reactant (2) include those of formula R_{f}—Rₖ—X—H, wherein R_{f} is a monovalent aliphatic group containing at least two carbon atoms each of which contains at least two fluorine atoms, R is a divalent organic radical, k is 0 or 1, X is O, S, or NR₁ wherein R₁ is H, a C₁ to C₆ alkyl, or an R_{f}—Rₖ group.

The first three components are reacted in a suitable solvent such as methylisobutylketone, in the presence of a catalyst such as a metal organic or a tertiary amine. Thereafter the remaining isocyanate groups are reacted with water to form one or more urea linkages. Further details of such fluorochemical urethanes and their preparation are as described in U.S. Pat. No. 5,827,919, which is incorporated in its entirety by reference.

Fluorinated surfactants suitable for use as the fluorochemical in the coatings of the present invention comprise a fluoroalkyl phosphate of Formula 6A or 6B

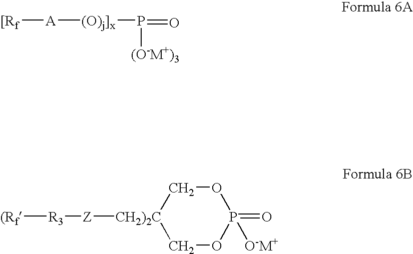

wherein:

R_{f} is F(CF₂CF₂)_{d}— or C₈F₁₇,

A is (CH₂)ₐ, CH₂CH₂(OCH₂CH₂)_{b}, CH═CH(CH₂)_{c}, or A is SO₂N(R)CH₂CH₂ when R_{f} is C₈F₁₇—,

R_{f′} is a fluoroaliphatic group having a linear or branched perfluorocarbon chain having from 2 to 20 carbon atoms,

x is from about 1 to about 2,

j is 1 or 0 or a mixture thereof,

d is 1 to about 8, or a mixture thereof, and preferably is from about 3 to about 6,

M⁺ is an ammonium ion, an alkali metal ion, or an alkanolammonium ion, such as ethanolammonium or diethanolammonium, and preferably is ammonium,

R₃ is an alkylene group having from 1 to about 8 carbon atoms, and is preferably ethylene,

Z is —O—, —S—, or —NH—,

a is from about 2 to about 10 and preferably is 2,

b is from about 3 to about 20 and preferably is from about 6 to about 13,

c is from about 2 to about 20, and preferably is 8, and R is H or an aliphatic group containing 1 to about 4 carbon atoms.

The fluoroalkylphosphates are prepared according to the method described by Brace and Mackenzie, in U.S. Pat. No. 3,083,224. Typically, either phosphorus pentoxide (P₂O₅) or phosphorus oxychloride (POCl₃) are reacted with the fluoroalcohols to give mixtures of the mono- and bis(perfluoroalkyl)phosphoric acids. Neutralization, using common bases such as ammonium or sodium hydroxides provides the corresponding phosphates. Reacting an excess of fluoroalcohol with P₂O₅ followed by neutralization provides an equimolar mixture of mono(perfluoroalkyl)phosphate and bis(perfluoroalkyl)phosphate. Higher ratios of bis(perfluoroalkyl)phosphate to mono(perfluoroalkyl)phosphate are obtained by using the method of Hayashi and Kawakami in U.S. Pat. No. 4,145,382. The salts of the fluoroalkylphosphates are preferred over the corresponding acids as outlined in U.S. Pat. No. 3,083,224 by reason of their increased water solubility. Examples of preparations of the fluorophosphates are given in U.S. Pat. No. 3,094,547.

In a further embodiment of this invention the coating composition comprises a polyfluoroalkyl phosphate of Formula 7

[CₘF₂ₘ₊₁CₙH₂ₙ—O]_{y}P(O)(OM)_{3-y} Formula 7

wherein

M is H, alkali metal ammonium, or NR¹R²R³ wherein each of R¹, R² and R³ are independently H, C₁ to C₂₀ alkyl, or C₁ to C₂₀ hydroxyalkyl,

m is an integer from 4 to 12,

n is an integer from 1 to 16,

y is a number of average value from 1.0 to 2.5,

provided that the two radicals Cₘ and Cₙ contain jointly a straight chain of not less than 8 carbon atoms.

The phosphates of Formula 7 are prepared by reacting the corresponding polyfluoroalkanol with phosphorus oxychloride in the presence of an acid acceptor such as pyrridine, or with phosphorus pentoxide, in the optional presence of an organic liquid diluent such as benzene, toluene, or xylene. Further details are provided in U.S. Pat. No. 3,083,224.

Also suitable for use herein as the fluorochemical component of the coating composition are phosphate esters containing a perfluoroalkyl group, or mixtures and salts thereof. Such polyfluoroalkyl phosphate esters are prepared using conventional techniques. For example, a hydroperfluoroalkanol is reacted with phosphoric anhydride to provide a mixture of perfluoroalkyl phosphate and pyrophosphate esters, This mixture is reacted with a glycol, such as ethylene glycol, to convert the pyrophosphate esters to mono-perfluoroalkylphosphate esters and bis-perfluoroalkyl/ethylene glycol phosphate esters. The mixture is then neutralized with a base such as ammonium hydroxide to obtain the phosphate ester salts. Further details on the preparation of these materials is contained in U.S. Pat. No. 3,083,224.

Also suitable for use herein are mixtures of a fluoroalkyl phosphate salt and a glycol ester. The fluoroalkyl pbosphate salt is prepared as described above and physically mixed with a glycol ester.

Another class of surfactants suited for use in the present invention is non-ionic surfactants such as perfluoroalkyl polyoxyethylenes having the Formula 8

R_{f}CₙH₂ₙQCₘH₂ₘ(C₂H₄O)ₗR Formula 8

wherein

n=1, 2, 4, 6;

m=0 to about 12;

I=5 about 15;

R_{f} is CₙF₂ₙ₊₁; (CF₃)₂CFOC₂F₄—; C₃F₇O[CF(CF₃)CF₂O)ₖCF₂—; C₃F₇O[CF(CF₃)CF₂O]ₖCF₂C(O)O—; or C₃F₇O[CF(CF₃)CF₂O]ₖCF₂CONH—;

k is 5 to 10;

Q is arylene, O, S, SO, SO₂;

R is H, CH₃, C₂H₅, or C(O)CH₃.

The compounds of Formula 8 when Q is O are prepared by conventional methods by reacting a fluorinated alcohol or fluorinated alcohol mixture with ethylene oxide in the presence of a catalyst. The catalyst is typically a mixed system comprising an alkali metal borohydride in combination with a source of iodine selected from elemental iodine, alkali metal iodide, or an alkaline earth metal iodide. Further details of such reactions are in U.S. Pat. No. 5,567,857 herein incorporated by reference.

The Q containing species are synthesized, starting with partially fluorinated thiols or thioethers such as R_{f}CₙH₂ₙSH and R_{f}CₙH₂ₙS CₘH₂ₘOH, respectively. The synthesis of these and related species containing telomer CₙF₂ₙ₊₁ as the fluorinated portion are taught in U.S. Pat. Nos. 2,642,416; 3,102,103; 3,282,905; 3,544,663; 3,655,732A; 3,773,826A; 3,786,089A; 3,808,251A; 4,302,366; 4,266,080; and 4,310,698. Their ethoxylation can be achieved using the same method applied for the telomer alcohols. In addition, thiols can be reacted with ω-halide, ω-tosylate, or ω-triflate terminated polyoxyalkylene via nucleophilic substitution reactions in a basic medium.

The fluorochemicals are incorporated into the coating base in concentrations sufficient to afford a dried coating containing from about 5 micrograms per gram to about 10,000 micrograms per gram by weight of fluorine, and preferably from about 50 micrograms per gram to about 5,000 micrograms per gram of fluorine, and most preferably from about 150 micrograms per gram to about 1,000 micrograms per gram of fluorine based on the nonvolatile content of the coating composition.

The content of organically bound fluorine was determined by conventional methods of elemental analysis: For this purpose, the test material was digested by combustion by the Wickbold or Schoniger method, the fluoride liberated was absorbed in water and the fluoride content of the resulting aqueous fluoride solution was determined potentiometrically with the aid of commercial fluoride ion-selective electrodes using a calibration curve. The content of organically bound fluoride in the sample can be easily calculated from the fluoride content of the solution measured in this manner and from the amount of sample used for combustion (literature: F. Ehrenberger: Quantitative Elementaranalyse; VCH Verlagsgesellschaft, Weinheimr, page 436 et seq., page 424 et seq., page 617 et seq.).

Many of the coating compositions of the present invention additionally comprise a pigment. Any pigment can be used in the present invention. The term “pigment” as used herein means opacifying and non-opacifying ingredients which are particulate and substantially non-volatile in use. Pigment as used herein includes ingredients labeled as pigments, but also ingredients typically labeled in the coating trade as inerts, extenders, fillers, and similar substances.

Representative pigments that can be used with the present invention include, but are not limited to, rutile and anatase TiO₂, clays such as kaolin clay, asbestos, calcium carbonate, zinc oxide, chromium oxide, barium sulfate, iron oxide, tin oxide, calcium sulfate, talc, mica, silicas, dolomite, zinc sulfide, antimony oxide, zirconium dioxide, silicon dioxide, cadmium sulfide, cadmium selenide, lead chromate, zinc chromate, nickel titanate, diatomaceous earth, glass fibers, glass powders, glass spheres, MONASTAL Blue G (C.I. Pigment Blue 15), molybdate Orange (C.I. Pigment Red 104), Toluidine Red YW (C.I. Pigment 3)-process aggregated crystals, Phthalo Blue (C.I. Pigment Blue 15)-cellulose acetate dispersion, Toluidine Red (C.I. Pigment Red 3), Watchung Red BW (C.I. Pigment Red 48), Toluidine Yellow GW (C.I. Pigment Yellow 1), MONASTRAL Blue BW (C.I. Pigment Blue 15), MONASTRAL Green BW (C.I. Pigment Green 7), Pigment Scarlet (C.I. Pigment Red 60), Auric Brown (C.I. Pigment Brown 6), MONASTRAL Green G (C.I. Pigment Green 7), MONASTRAL Maroon B, MONASTRAL Orange, and Phthalo Green GW 951.

Titanium dioxide (TiO₂) is the preferred pigment to use in the present invention. Titanium dioxide pigment, useful in the present invention, can be in the rutile or anatase crystalline form. It is commonly made by either a chloride process or a sulfate process. In the chloride process, TiCl₄ is oxidized to TiO₂ particles. In the sulfate process, sulfuric acid and ore containing titanium are dissolved, and the resulting solution goes through a series of steps to yield TiO₂. Both the sulfate and chloride processes are described in greater detail in “The Pigment Handbook”, Vol. 1, 2nd Ed., John Wiley-& Sons, NY (1988), the teachings of which are incorporated herein by reference.

Titanium dioxide particles have an average size of generally less than 1 micron but can vary up to as large as an average size of 10 microns. Preferably, the particles have an average size from about 0.020 to about 0.95 microns, more preferably, from about 0.050 to about 0.75 microns and most preferably from about 0.075 to about 0.50 microns.

If the pigment is titanium dioxide it can be substantially pure titanium dioxide or can contain other metal oxides, such as silica, alumina, zirconia, and the like. Other metal oxides can become incorporated into the pigment particles for example, by co-oxidizing or co-precipitating titanium compounds with other metal compounds. If co-oxidized or co-precipitated metals are present, they are preferably present in an amount from about 0.1 to about 20 percent by weight, as the metal oxide, preferably, from about 0.5 to about 5 percent by weight, more preferably from about 0.5 to about 1.5 percent by weight based on the total pigment weight.

The titanium dioxide pigment can also bear one or more metal oxide surface coatings. These coatings can be applied using techniques known by those skilled in the art. Examples of metal oxide coatings include silica, alumina, and zirconia, among others. Such coatings can be present in an amount from about 0.1 to about 10 percent by weight, based on the total weight of the pigment, preferably from about 0.5 to about 3 percent by weight.

The titanium dioxide pigment is surface treated to provide metal oxide surface coatings. By “surface treated” it is meant titanium dioxide pigment particles that have been contacted with the compounds described herein wherein the compounds are adsorbed on the surface of the titanium dioxide particle or a reaction product of at least one of the compounds with the titanium dioxide particle is present on the surface as an adsorbed species or chemically bonded to the surface. The compounds or their reaction products or combination thereof can be present as a coating, either single layer or double layer, continuous or non-continuous, on the surface of the pigment. Typically, a continuous coating comprising a silicon-containing compound and an organic compound is on the surface of the pigment.

Non-limiting commercial examples of such coated titanium dioxide pigments include TI-PURE R706 and TI-PURE R931, available from E.I. du Pont de Nemours and Company, Wilmington, Del.; TIOXIDE R-XL and R-HD4, available from Huntsman Tioxide, Billingham, England; TIONA RCL-3, R^{C}L-376, and RCL-373 available from Millennium Chemicals, Inc., Hunt Valley, Md.; KRONOS 2044, 2131, 2043, and 2047, available from Kronos Worldwide, Incorporated, Dallas, Tex.; TIPAQUE R-780 and R-780-2 available from Ishihara Sangyo Kaisha, Limited, Osaka, Japan; KEMIRA RDE2, RDD, RDD1, OR-572, and OR-573 available from Kemira Oyj, Helsinki, Finland; PGE-113 available from Cristal, Jeddah, Saudi Arabia; JR-800 and JR-801 available from Tayca Corporation, Osaka, Japan; R-7E available from Sakai Chemical Industry Company, Limited, Osaka, Japan; TYTANPOL R-211 available from LG Chem, Seoul, Korea; KEMOX CR-813 available from Kerala Minerals and Metal, Limited, Kollam, India; RC84 available from Cinkarna, Celje, Slovenia; and CR-813, RD, and R-500, available from Kerr-McGee Corporation, Oklahoma City, Okla.

The present invention is used with almost any coating base. For non-limiting examples, it can be used with an alkyd coating, a urethane coating, an unsaturated polyester coating, and a water-dispersed coating as previously defined. A common example is use with a latex coating, or a flat-based coating for household decoration.

The amount of polyoxyalkylene siloxane additive added to the coating base composition is such that the polyoxyalkylene siloxane additive is between about 0.01% and about 10% by weight in the final liquid coating composition, preferably the polyoxyalkylene siloxane additive is between about 0.05% and about 5.0% by weight in the final liquid coating composition, and more preferably from about 0.2% to about 0.5% by weight in the final liquid coating composition. The quantity of fluorochemical added to the coating base is such that the fluorochemical is from about 0.001% to about 10% by weight of the final liquid coating composition, preferably from about 0.01% and 5% of the final liquid coating composition, and more preferably from about 0.05% to about 1% of the final liquid coating composition. The dry coating resulting form the coating composition will contain between about 5 micrograms per gram to about 10,000 micrograms per gram by weight of fluorine, preferably from about 50 micrograms per gram to 5,000 micrograms per gram by weight of fluorine, and more preferably from about 150 micrograms per gram to 1,000 micrograms per gram by weight of fluorine. The weight ratio of fluorochemical to siloxane additive can range from about 1:99 to about 99:1, and preferably is from about 3:1 to about 1:3.

The fluorochemical and polyoxyalkylene siloxane are mixed into a coating base prior to use. These chemicals are mixed into the coating base in any way that allows for thorough distribution of the ingredients of within the coating base. The preferred method is to introduce the total of the fluorochemical and siloxane to coating base followed by shaking on a mechanical shaker or mechanical stirring. The introduction of the chemicals to the coating base can occur at any time, including during manufacture, prior to sale, at the point of sale, or by the end-user prior to application of the product coating composition. It is preferred that the fluorochemical and siloxane additives used in the present invention are added to the coating base at the time color pigments are added.

The present invention further comprises a dried coating comprising a protective film obtained after the volatile components of a coating composition comprising a polyoxyalkylene siloxane additive and a fluorochemical, as described above, have evaporated, dried, cured or otherwise dissipated. The drying properties of the coating compositions are essentially unaffected by the presence of the polyoxyalkylene siloxane additive, or the presence of both the siloxane additive and fluorochemicals.

Methods of application of the coating compositions of the present invention to surfaces are conventional. Non-limiting examples include application by brush, roller, pad, sponge, mat, clothes, combs, paper, feather, stylus., knife, spray applicator, or other applicator tools. After drying, the dried coating has durable oil repellency, improved cleanability, improved resistance to blocking, and improved open time. These desirable attributes remain after repeated cleaning as demonstrated by the retention of the hexadecane contact angle and as shown by direct measure or demonstrated benefit of repeated cleanability.

The present invention further comprises a method of providing durable cleanability of a surface having deposited thereon a dry coating composition comprising adding to the coating composition prior to drying a polyoxyalkylene siloxane and a fluorochemical of Formula 6A, 7 or 8, or a mixture thereof with fluoroalkyl phosphate glycol esters, or a fluorochemical polyurethane as previously described. Preferred are a fluorochemical selected from the group consisting of 1) fluorinated urethane, 2) fluoroalkyl phosphate and salt thereof, 3) fluoroalkyl phosphate ester and salt thereof, 4) a mixture of a fluoroalkyl phosphate and a glycol ester, and 5) fluoroalkylpolyoxyethylene. The polyoxyalkylene siloxane additive is as described above, and needs to be pure. It has been found that when impurities are present in the siloxane additive that cleanability performance is decreased. The polyoxyalkylene siloxane and fluorochemical are added to the coating base using the methods and in the amounts as described above. The cleanability is durable and therefore retained through multiple cleanings of the coated substrate surface. The cleanability is improved and durability enhanced compared to a conventional coating composition which does not contain the polyoxyalkylene siloxane and fluorochemical used in the coating compositions of the present invention.

The present invention further comprises a method of providing oil repellency to a surface having deposited thereon a dry coating composition comprising addition to the coating composition prior to drying of a polyoxyalkylene siloxane as previously described and any of the fluorochemicals as previously described. The chemicals are added to the coating base using the methods and in the amounts as described above. The oil repellency of the coating compositions of the present invention is improved compared to a conventional coating composition which does not contain the polyoxyalkylene siloxane and fluorochemical used in the coating compositions of the present invention.

The present invention further comprises a method of providing resistance to blocking of a surface having deposited thereon a dry coating composition comprising addition to the coating composition prior to drying of a polyoxyalkylene siloxane as previously described and a fluorochemicals of Formula 6A, 7 or 8 as described above. Preferred fluorochemicals are selected from the group consisting of 1) fluoroalkyl phosphate and salt thereof, 2) fluoroalkyl phosphate ester and salt thereof, 3) a mixture of a fluoroalkyl phosphate and a glycol ester, and 4) fluoroalkylpolyoxyethylene. The chemicals are added to the coating base using the methods and in the amounts as described above. Blocking is the undesirable sticking together of two coated surfaces when pressed together, or placed in contact with each other for an extended period of time. When blocking occurs separation of the surfaces can result in disruption of the coating on one or both surfaces. Thus improved resistance to blocking is beneficial in many situations where two coated surfaces need to be in contact, for example on window frames. The resistance to blocking of the coating compositions of the present invention is improved compared to a conventional coating composition which does not contain the polyoxyalkylene siloxane and fluorochemical used in the coating compositions of the present invention.

The present invention further comprises a method of extending the open time extension of a coating during application of the coating to the surface comprising addition to the coating composition of a polyoxyalkylene siloxane as previously described and any of the fluorochemicals as previously described. The chemicals are added to the coating base using the methods and in the amounts as described above. A longer open time extension is beneficial when the appearance of the coated surface is important, as it permits application of the coating without leaving overlap marks, brush marks, or other application marks at the area of overlap between one layer of the coating and an adjacent layer of the coating. The open time extension of the coating compositions of the present invention is longer (improved) compared to a conventional coating composition which does not contain the polyoxyalkylene siloxane and fluorochemical used in the coating compositions of the present invention.

The present invention further comprises a method of providing soil resistance (resistance to dirt pick-up) of a surface having deposited thereon a dry coating composition comprising addition to the coating composition prior to drying of a polyoxyalkylene siloxane as described above and any of the fluorochemicals as previously described. The chemicals are added to the coating base using the methods and in the amounts as described above. Soil resistance is used herein to mean resistance to pick up of soil or dirt. This results from the presence of both repellency and increased sheeting of water or liquids off of the surface coated with a composition of the present invention. It is indicated by the presence of a high advancing hexadecane contact angle in combination with a low advancing water contact angle. This combination of properties is especially useful for exterior surfaces exposed to ambient weather conditions. Normal rainfall washes away soil from the surface coated with a coating composition of the present invention, rendering it cleaner for a longer time period when compared to surfaces coated with a coating composition not containing the polyoxyalkylene and fluorochemicals used in the present invention.

The present invention further comprises a method of providing wetting and leveling to a coating during application of the coating to the surface comprising addition to the coating composition prior to application of a polyoxyalkylene siloxane as previously described and any of the fluorochemicals as previously described. The chemicals are added to the coating base using the methods and in the amounts as described above. The wetting and leveling of the coating compositions of the present invention is improved compared to a conventional coating composition which does not contain the polyoxyalkylene siloxane and fluorochemical used in the coating compositions of the present invention. This provides a smoother appearance to the resulting dried coating.

The coating compositions and methods of the present invention are useful for providing a protective and/or decorative coating to a wide variety of substrates using less fluorochemical than in conventional coatings. Upon application, such coating compositions dry or cure by conventional methods and the dried coatings of the present invention exhibit several valuable properties. Specifically, the dried coatings of this invention, compared with conventional dried coatings, exhibit improved oil repellency, cleanability, resistance to blocking, and soil resistance. During application the coating compositions of the present invention have longer open time extension and improved wetting and leveling, resulting in a smoother surface coating.

### Test Methods and Materials

The following test methods and materials were used in the Examples herein.

### Test Methods

### Method 1—Leneta Oil Stain Test

The test method described herein is a modification of ASTM 3450-00—Standard Test Method for Washability Properties of Interior Architectural Coatings, which is hereby specifically incorporated by reference.

Drawdowns were prepared by applying a coat of coating composition on Leneta Black MYLAR cards (The Leneta Company, Mahwah, N.J.) using a BYK-Gardner automatic drawdown machine (BYK-Gardner, Silver Spring, Md.) and a 5 mil (0.127 mm) Bird applicator drawdown blade (BYK-Gardner, Silver Spring, Md.). The drawdown speed was set to be slow enough to prevent pinholes or holidays in the resulting coating. Several drawdowns were prepared for each paint and additive combination. The coated cards were allowed to dry for seven days for testing for cleanability.

Staining media were prepared using VASELINE NURSERY JELLY (Marietta Corporation, Cortland, N.Y.) and Leneta Carbon Black Dispersion in Mineral Oil (ST-1) (The Leneta Company, Mahwah, N.J.). The petroleum jelly was melted in a clean glass container for 30 minutes in an oven set at 70° C. Then the petroleum jelly was mixed with 5% of its weight of Leneta Carbon Black. For instance, 95 g of petroleum jelly was mixed with 5 g of Leneta Carbon Black to produce 100 g of staining media. The mixed staining media was cooled for several hours in a refrigerator at 4° C.

Cleaning media were prepared using a JOY ULTRA CONCENTRATED COUNTRY LEMON dishwashing liquid (The Procter & Gamble Company, Cincinnati, Ohio). Dishwashing liquid was mixed with deionized water at a ratio of 1 g of dishwashing liquid for every 99 g of water.

Each drawdown was stained in the same manner. A staining template was prepared from a MYLAR Leneta card by cutting out a 3″ by 1″ (7.6 cm by 2.5 cm) strip from the interior of the card. The template was placed over a coated drawdown card to be stained. Staining media was spread over the drawdown card and the template using a spatula so that none of the drawdown card remained visible. Excess stain was removed with a spatula. Stained cards were allowed to set and dry for 60 minutes.

In preparation for cleaning, scrap MYLAR was used to gently scrape the excess dried stain from the stained section of the card, both the washed and unwashed sections. Similarly a c-folded clean paper towel was used to remove unset stain from the entire card, both the washed and unwashed sections. The card was then securely attached to a BYK-Gardner Abrasion tester (BYK-Gardner, Silver Spring, Md.) or other method. A piece of cheesecloth (VWR International, San Diego, Calif.) was attached to the cleaning block on the abrasion tester. The cheesecloth was folded and attached so that the contacting surface was 8 layers thick. 10 mL of cleaning solution prepared as specified above was applied to the contacting surface of the cheesecloth. The abrasion tester was run through 5 cycles (10 wipes) over a stained section of the drawdown card that is henceforth designated as stained and cleaned. Excess cleaning solution was rinsed away with deionized water for a few seconds and then allowed to dry for 2 hours or until completely dry by visible inspection. One section of each stained drawdown card was cleaned in this manner.

Cleanability was determined by evaluating the stained and washed painted portion of the drawdown card in comparison to both the unstained and painted portion of the card and the stained and unwashed painted portion of the card. A HunterLab ULTRASCAN Pro calorimeter (Hunter Associates Laboratory, Inc, Reston, Va.) was used to take three different measurements for each designated painted portion of the drawdown card: stained and washed, unstained, and stained and unwashed. The measurements were averaged to obtain a mean value for that section that is used to evaluate the cleanability rating for that card as described below. The colorimeter was set to read the L* function and the aperture was no larger than ¾ of an inch (1.9 cm).

A cleanability score was calculated ranging from 0-10 wherein 0 is uncleanable, and 10 is completely cleanable. Values 1-9 were established in numerical order equidistant from 0, 10, and one another on a linear slope. The above description fits the following equation: [(mean L*value of stained and washed painted section)−(mean L*value of stained and unwashed painted section)]/[(mean L*value of unstained-painted section)−(mean L*value of stained and unwashed painted section)]*10=cleanability rating.

### Method 2—Blocking Resistance of Architectural Paints.

The test method described herein is a modification of ASTM D4946-89—Standard Test Method for Blocking Resistance of Architectural Paints, which is hereby specifically incorporated by reference.

The face-to-face blocking resistance of paints to be tested was evaluated in this test. Blocking, for the purpose of this test, is defined as the undesirable sticking together of two painted surfaces when pressed together or placed in contact with each other for an extended period of time.

The paint to be tested was cast on a polyester test panel using the applicator blade. All painted panels should be protected from grease, oil, fingerprints, dust, et cetera; surface contamination will affect blocking resistance results. Typically, results are sought at 24 hours after casting the paint. After the panels have been conditioned in the conditioned room for the desired period of time, six squares (3.8 cm×3.8 cm) were cut out from the painted test panel. The cut sections (three pairs) were placed with the paint surfaces face-to-face for each of the paints to be tested. The cut sections (three pairs) were placed with the paint surfaces face-to-face for each of the paints to be tested. The face-to-face specimens were placed in a 50° C. oven on a marble tray. A no. 8 stopper was placed on top, with the smaller diameter in contact with the specimens, and then a 1000 g weight was placed on top of the stopper. This resulted in a pressure of 1.8 psi (12.4×10³ Pa) on the specimens. One weight and stopper were used for each specimen to be tested. After exactly 30 minutes, the stoppers and weights were taken off the test specimens which were removed from the oven and allowed to cool in the conditioned room for 30 minutes before determining the block resistance.

After cooling, the specimens were separated by peeling apart with a slow and steady force. The blocking resistance was rated from 0 to 10, corresponding to a subjective tack assessment (sound made upon separation of the painted specimens) or seal (complete adhesion of the two painted surfaces) as determined by the operator of the method. The specimen was put near the ear to actually hear the degree of tack. The rating system is described in Table 1. The degree of seal was estimated from the appearance of the specimens and the fraction of the paint surfaces that adhere. Paint tearing away from the test panel backing was an indication of seal. A higher number indicates better resistance to blocking.

TABLE 1
Blocking Resistance Numerical Ratings

| Blocking Resistance | Description of the | Performance |
|---|---|---|
| Numerical Ratings | Separation | Description |
| 10 | no tack | perfect |
| 9 | trace tack | excellent |
| 8 | very slight tack | very good |
| 7 | slight tack | good/very good |
| 6 | moderate to slight tack | good |
| 5 | moderate tack | fair |
| 4 | very tacky - no seal | poor to fair |
| 3 | 5 to 25% seal | poor |
| 2 | 25 to 50% seal | poor |
| 1 | 50 to 75% seal | very poor |
| 0 | 75 to 100% seal | very poor |

### Method 3—Detergent Wash Durability

Wash durability of the coating compositions containing polyoxyalkylene siloxane additive and fluorochemical to surface cleaning was determined using a Gardco Model D10 Wash & Wear Tester (Paul N. Gardner Co., Pompano Beach, Fla.) and a GARDCO WA-2225 abrasion boat. A 6.5×1 inch (16.5×2.5 cm) test strip cut from a coated Leneta test panel was positioned on the test sample tray and fastened thereto with ¾ inch (1.9 cm) wide transparent tape such that about a 2×¾ inch (5.1×1.9 cm) portion of the coated test panel would be scrubbed. The abrasion boat base plate was covered with a folded 9×9 inch (22.9×22.9 cm) piece of De Royal Textiles IDEALFOLD bleached grade 20B cotton cheesecloth available from DeRoyal Textiles, Camden, S.C. The cheesecloth was folded perpendicular to the seam in half, and half again, and was fastened to the base plate such that the scrubbing surface layers were seam free. The cheesecloth pad was wet with 20 ml of a 1% aqueous JOY detergent as described above (Proctor & Gamble Co., Cincinnati, Ohio) solution before the test strip was scrubbed. The test strip was removed after a predetermined number of scrub cycles, washed free of the JOY solution with water, and air dried one day before the test strips were evaluated using the Leneta oil Stain test, Test Method 1, described above. A higher number indicates better durability of the cleanability.

### Method 4—Contact Angle Measurement

Contact angles are measured by the Sessile prop Method, which is described by A. W. Adamson in The Physical Chemistry of Surfaces, Fifth Edition, Wiley & Sons, New York, N.Y., 1990. Additional information on the equipment and procedure for measuring contact angles is provided by R. H. Dettre et al. in “Wettability”, Ed. by J. C. Berg, Marcel Dekker, New York, N.Y., 1993.

In the Sessile prop Method, a Ramè-Hart optical bench (available from Ramè-Hart Inc., 43 Bloomfield Ave., Mountain Lakes, N.J.) is used to hold the substrate in the horizontal position. The contact angle is measured at a prescribed temperature with a telescoping goniometer from the same manufacturer. A drop of test liquid is placed on a surface and the tangent is precisely determined at the point of contact between the drop and the surface. An advancing angle is determined by increasing the size of the drop of liquid and a receding angle is determined by decreasing the size of the drop of liquid. The data are presented typically as advancing and receding contact angles.

The relationship between water and organic liquid contact angles, and the cleanability and dirt retention of surfaces is described by A. W. Adamson, above. In general, higher hexadecane contact angles indicate that a surface has greater dirt and soil resistance, and easier surface cleanability.

By durable oil repellency and durable increased hexadecane contact angles are meant that the advantageous surface properties of modified dried coatings of the present invention are retained following repeated surface cleaning.

The water and hexadecane advancing and of the dried coating compositions of the present invention were measured on coatings cast on Leneta P-121-10N dull black, scrub test panels available from Leneta Company, Mahwah, N.J.

### Method 5—Open-Time Measurement

Open-time testing is conducted by a well accepted industry practice, called thumb press method as described herein: A double strip drawndown panel coated with the control and the sample to be tested are employed. The control and the sample to be tested are the same coating composition wherein the control contains no additives and the sample to be tested contains a polyoxyalkylene siloxane additive, or the polyoxyalkylene siloxane additive and fluorochemical. The panel is made with a 0.7 cm doctor blade at 20-25° C., 40-60% relative humidity. A double thumb press with equal pressure is then applied to each sample side by side at 1-2 minute intervals. The end point is when no paint residue on the thumb is observed. The time from when the drawdown is made to the end point is recorded as open-time. The percent difference between the control and sample being tested is recorded as percent open time extension.

### Test Method 6—Surface Tension

The desired amount of a given fluorosurfactant, x grams, is measured via a pipette into a glass bottle placed on an analytical balance. The polyoxyalkylene siloxane surfactant, of desired y grams, is then added to the bottle containing the fluorosurfactant to give a 1.0 g total (1.0-% ingredient) mixture of fluorosurfactant and trisiloxane. The mixture is diluted on the balance with 99.0 grams of water to give a 100.0 g (100%) total aqueous solution. A variety of solutions of decreasing concentrations of fluorosurfactant and increasing concentrations of trisiloxane, all totaling 1.0 g (1.0 weight % ingredients), were prepared as well as 1.0 weight % ingredients of both the fluorosurfactant and trisiloxane.

The 1.0-% aqueous solutions prepared above were allowed to stir for a period of 18-24 hours to ensure mixing and dispersing of the active materials. Each solution was used to prepare dilutions of its corresponding set. Each set consisted of a fluorosurfactant and trisiloxane aqueous solution of concentration x+y totaling 1.0% (a stock solution). The solutions prepared were as listed in Tables 7 and 8. Each dilution prepared was inverted and shaken a few times to ensure homogenous mixtures before performing the succeeding dilutions.

Each fluorosurfactant varies on the amount of active ingredient, where as the trisiloxane used is 100% active ingredient. Therefore, each fluorosurfactantltrisiloxane blend was adjusted accordingly in the data presented to give the total % active ingredient of each solution.

Each dilution was used and an equilibrium surface tension was obtained. An aliquot of each solution (30 mL) was poured into a glass dish and allowed to equilibrate for 20-30 seconds before measurements were taken. The measurements were provided using a Krüss K 11 tensiometer using the ‘Wilhelmy Plate Method’ wherein a small platinum plate with a roughened surface is suspended perpendicular to the liquid surface contented in a glass dish. Each dish was filled with 30 mL of solution. The plate is attached to a force measuring balance. The liquid glass dish containing stage is raised manually until the surface of the solution is a few millimeters in distance from the suspended plate. The stage is then raised electronically and the wetting of the plate provides for a force proportional to the surface tension of the liquid. The mean surface tension value was collected from ten consecutive readings to give the values recorded.

### Materials

The following materials were employed in the examples hereinafter unless otherwise indicated.

A. Coating Bases (Paints)

The following paints are commercially available from Lowe's, Wilmington, Del., or other locations.

Paint #1 was latex flat interior which had an acrylic resin and 4% gloss at 85 degrees.

Paint #2 was latex flat which had a styrene acrylic resin and 2% gloss at 85 degrees.

Paint #3 was semi-gloss which had an acrylic resin and 52% gloss at 60 degrees.

Paint #4 was latex flat interior, which had an acrylic resin and 3% gloss at 85 degrees.

Paint #5 was latex flat which had a vinyl acrylic resin and 2% gloss at 85 degrees.

TABLE A

| Paint | Fluorine Content (ppm) |
|---|---|
| Paint 1 | 2.5 |
| Paint 2 | 166 |
| Paint 3 | 3.9 |
| Paint 4 | 62.6 |
| Paint 5 | 32.5 |

Table A lists the elemental fluorine content of each paint as purchased as determined by Wickbold torch analysis previously described. This represents the fluorine content of the paints, as purchased, prior to the addition of any of the fluorochemicals used in the present invention.

B. Fluorochemicals

1) Fluorochemical 1 was a polyfluorourethane prepared as described in U.S. Pat. No. 5,827,919, and available from E.I. du Pont de Nemours and Company, Wilmington, Del.

2) Fluorochemical 2 was a fluorocarbon surfactant, which is a mixture of a fluoroalkyl phosphate ammonium salt and a glycol ester, available from E.I. du Pont de Nemours and Company, Wilmington, Del.

3) Fluorochemical 3 was a fluoroalkyl ethoxylate in water, prepared as in U.S. Pat. No. 5,567,857, and available from E.I. du Pont de Nemours and Company, Wilmington, Del.

4) Fluorochemical 4 is an aqueous solution of the ammonium salts of fluoroalkyl phosphate in water, prepared as in U.S. Pat. No. 3,083,224, and available from E.I. du Pont de Nemours and Company, Wilmington, Del.

C. Polyoxyalkylene Siloxanes Additives

1) Polyoxyalkylene siloxane additive #1 is a polyoxyethylene trisiloxane Q2-5211, available from Dow Corning Corporation, Midland, Mich. This additive is noted in the tables and drawings as trisiloxane ethoxylate 1.

2) Polyoxyalkylene siloxane additive #2 is Silwet L-7280 available from GE Silicones General Electric Company, Wilton, Conn. This additive is noted in the tables as trisiloxane ethoxylate 2.

3) Polyoxyalkylene siloxane additive #3 is a polyoxyethylene trisiloxane Q2-5212, available from Dow Corning Corporation, Midland, Mich. This additive is noted in the tables as trisiloxane ethoxylate 3.

4) Polyoxyalkylene siloxane additive #4 is a polyoxyethylene trisiloxane Silsurf A012, available from Siltech Corporation, Toronto, Ontario. This additive is noted in the tables as trisiloxane ethoxylate 4.

D. Stains

1) Leneta Carbon Black Dispersion in Mineral Oil (ST-1) available from The Leneta Company, Mahwah, N.J.

2) VASELINE NURSERY JELLY, available from Marietta Corporation, Cortland, N.Y.

E. Cleaning Compositions

1) JOY Ultra Concentrated Country Lemon dishwashing liquid, available from The Procter & Gamble Company, Cincinnati, Ohio.

### EXAMPLES

In all tables percentages of additives are by weight unless otherwise indicated.

### Example 1

The coating compositions and materials used are described in the Materials section. The samples used in Example 1 were prepared by combining the designated coating base (paint), polyoxcyalkylene siloxane, and fluorochemical according to the description and amounts as weight percent provided in Tables 2A and 2B. The components were thoroughly mixed by mechanical shaking. Care was taken to prevent the development of foam and to allow any foam that did develop to dissipate. The control sample did not receive any polyoxyalkylene siloxane additive nor any additional fluorochemical. The resulting formulations were tested for cleanability using Test Method 1. The results are in Tables 2A and 2B. The values are a relative score of cleanability wherein 0 is uncleanable and 10 is completely cleanable.

TABLE 2A
Cleanability

| Samples | Paint #1 | Paint #2 | Paint #4 | Paint #5 |
|---|---|---|---|---|
| None - Control | 3.4 | 5.2 | 4.4 | 6.8 |
| 0.5% Fluorochemical | 5.4 | 9.4 | 5.9 | 7.9 |
| #1 | | | | |
| 0.1% Fluorochemical | | 7 | 4.2 | 7.5 |
| #4 | | | | |
| 0.2% Polyoxyalkylene | 6.8 | 9.8* | 4.9 | 7.7 |
| siloxane #1 | | | | |
| 0.2% Polyoxyalkylene | — | 9.8* | 4.5 | — |
| siloxane #2 | | | | |
| 0.2% Polyoxyalkylene | 9.2 | 9.9 | 7.2 | 8.3 |
| siloxane #1 and 0.5% | | | | |
| Fluorochemical #1 | | | | |
| 0.2% Polyoxyalkylene | — | 9.9 | 6.6 | — |
| siloxane #2 and 0.5% | | | | |
| Fluorochemical #1 | | | | |
| 0.2% Polyoxyalkylene | — | 9.9 | 6 | 7.7 |
| siloxane #1 and 0.1% | | | | |
| Fluorochemical #4 | | | | |
| 0.2% Polyoxyalkylene | — | 9.8 | 5.2 | — |
| siloxane #2 and 0.1% | | | | |
| Fluorochemical #4 | | | | |
| 0.7% Fluorochemical | 6 | — | — | — |
| #1 | | | | |

*Rating from colorimeter is not representative of visual stain remaining in a peppering pattern wherein the coating appears to have specs of soil in it. All percentages are by weight.

TABLE 2B
Cleanability

| | Paint #1 | Paint #4 |
|---|---|---|
| Control | 4.3 | 4.0 |
| 0.5% Fluorochemical #1 | 4.5 | 4.6 |
| 0.1% Fluorochemical #4 | 4.4 | 4.9 |
| 0.5% Fluorochemical #1 + 0.2% | 4.9 | 6.1 |
| Polyoxyalkylene | | |
| siloxane #3 | | |
| 0.1% Fluorochemical #4 + 0.2% | 5.4 | 4.7 |
| Polyoxyalkylene | | |
| siloxane #3 | | |
| 0.2% Polyoxyalkylene | 3.1 | 5.5 |
| siloxane #3 | | |

The data in Table 2A demonstrates generally improvement in the cleanability of the test paints by addition of either the polyoxyalkylene siloxane additive or the fluorochemical. The data also demonstrate, in many instances, enhanced improvement in the cleanability performance of the test paints by the combination of fluorochemicals and polyoxyalkylene siloxanes. The performance of Paint #2 was significantly improved solely by the addition of polyoxyalkylene siloxane #1 and polyoxyalkylene siloxane #2 due to the fluorine content from manufacturer's formulation shown in Table A of the Materials section. The further improvement of the performance of paint #2 by the addition of the blend of fluorochemical and polyoxyalkylene over the polyalkylene alone can be seen in the present invention where a visually distinguishable peppering pattern was observed, wherein the stain remained visible in a spotty irregular pattern.

The data in Table 2B represents improvement in cleanability with a polyoxyalkylene siloxane #3 and the fluorochemical. This siloxane had a longer polyoxyalkylene chain than in the siloxanes listed in Table 2A, giving rise to a higher molecular weight. For this reason, it is believed that performance was slightly less due to the lesser amount of percent active ingredient.

### Example 2

Coating compositions were prepared in a manner similar to Example 1 having the compositions shown in Table 3. The coating base used was Paint #3 as listed in the Materials section. The blocking resistance tests were conducted according to Test Method 2. The results are in Table 3 with a higher rating indicating superior resistance.

TABLE 3
Blocking Resistance

| Additive | Blocking Rating |
|---|---|
| None - Control | 0 |
| 0.10% Polyoxyalkylene siloxane #1 | 2 |
| 0.10% Fluorochemical 2 | 3 |
| 0.033% Polyoxyalkylene siloxane #1 | 2 |
| and 0.066% Fluorochemical 2 | |
| 0.066% Polyoxyalkylene siloxane #1 | 6 |
| and 0.033% Fluorochemical 2 | |
| 0.080% Polyoxyalkylene siloxane #1 | 7 |
| and 0.020% Fluorochemical 2 | |

The data in Table 3 demonstrates improvement in blocking resistance by addition of either the polyoxyalkylene siloxane additive, the fluorochemical, or combinations thereof. The data also demonstrate enhanced improvement in blocking performance by the addition of polyoxyalkylene siloxanes with fluorochemicals provided that a certain minimum level of polyoxyalkylene siloxane was present.

### Example 3

Coating composition samples were prepared according to the methods used in Example 1. The coating base used was Paint #2 as listed in the Materials section. Control samples were prepared so as not to contain any additional additives. Experimental samples were prepared to the combination of both polyoxyalkylene siloxane additive #1 and fluorochemical 1 as described in Table 4. Experimental samples and control samples coating compositions were applied to test panels and tested according to Test Method 1.

Wash durability tests were performed according the Test Method 3 under the specifications of Table 4. The results are in Table 4. A higher number indicates better performance.

TABLE 4
Durability of Cleanability

| Additive | 0 Cycles | 20 Cycles | 50 Cycles |
|---|---|---|---|
| None - Control | 4.4 | 3.3 | 4.5 |
| 0.2% | 6.2 | 7.3 | 6.3 |
| Polyoxyalkylene | | | |
| siloxane #1 | | | |
| 0.5% Fluorochemical 1 | 3.7 | 5.7 | 5.2 |
| 0.2% | 9.2 | 9.1 | 8.5 |
| Polyoxyalkylene | | | |
| siloxane #1 and 0.5% | | | |
| Fluorochemical 1 | | | |

Table 4 demonstrates the durability of the coating compositions described in Table 4 and associated cleanability performance. Table 4 indicates, through only slight decrease in performance after 50 cycles, that the improvement of cleanability performance was not due to a sacrificial surface layer. For each test an enhanced improvement was obtained when both the fluorochemical and the polyoxyalkylene siloxane were present.

### Example 4

Coating composition samples were prepared according to the methods used in Example 1. The coating base used was Paint #1 and Paint #2 as listed in the Materials section. Control samples were prepared so as not to contain any additional additives. Experimental samples were prepared to contain polyoxyalkylene siloxane additive #1, fluorochemical 1, or the combination of both polyoxyalkylene siloxane additive #1 and fluorochemical 1 as described in Table 5. Experimental sample and control sample coating compositions were applied to test panels according to the procedures in Test Method 1. The contact angle test was performed according the Test Method 4. The results are in Table 5.

TABLE 5A
Contact Angle

| Coating Base Paint #2 | Advancing | |
|---|---|---|
| Combined with | Hexadecane | Advancing Water |
| These Additive(s) | Contact Angle | Contact Angle |
| None - Control | 38 | 87 |
| 0.5% Fluorochemical 1 | 49 | 83 |
| 0.1% Polyoxyalkylene | 46 | 74 |
| siloxane #1 | | |
| 0.2% Polyoxyalkylene | 44 | 71 |
| siloxane #1 | | |
| 0.5% Fluorochemical 1 | 49 | 74 |
| and 0.1% | | |
| Polyoxyalkylene siloxane | | |
| #1 | | |
| 0.5% Fluorochemical 1 | 61 | 64 |
| and 0.2% | | |
| Polyoxyalkylene siloxane | | |
| #1 | | |

TABLE 5B
Contact Angle

| Coating Base Paint #1 | Advancing | |
|---|---|---|
| Combined with | Hexadecane | Advancing Water |
| These Additive(s) | Contact Angle | Contact Angle |
| None - Control | 0 | 87.7 |
| 0.5% Fluorochemical #1 | 64.9 | 76.4 |
| 0.2% Polyoxyalkylene | 0 | 78.7 |
| siloxane #1 | | |
| 0.2% Polyoxyalkylene | 0 | 71.6 |
| siloxane #4 | | |
| 0.5% Fluorochemical 1 | 73.9 | 45.6 |
| and 0.2% | | |
| Polyoxyalkylene siloxane | | |
| #1 | | |
| 0.5% Fluorochemical 1 | 73.7 | 41.6 |
| and 0.2% | | |
| Polyoxyalkylene siloxane | | |
| #4 | | |

The data in Table 5A show an increase in the advancing hexadecane contact angle for the coating compositions of the present invention containing the polyoxyalkylene siloxane additive and/or the fluorochemical, which correlates with Improved oil repellency and cleanability. The data also show a decrease in the advancing water contact angle which correlates with increased water sheeting ability. Thus when water contacts the surface it has increased sheeting and runs off the surface faster. This contributes to improved soil resistance, especially for exterior surfaces in contact with rain. The rain effectively washes away more soil as the water contact angle decreases to achieve a self cleaning effect to maintain the surface cleaner for a longer time period.

The data in Table 5B demonstrates the general trend of decreasing water contact angle, and also an increase in hexadecane contact angles when both the fluorochemical and polyoxyalkylene siloxane were present. Polyoxyalkylene siloxane additive #4 had a higher molecular weight compared to the other polyoxyalkylene siloxane additives tested and was found to contain impurities. In this application, impurities did appear to impede on performance. Generally the hexadecane contact angle was still high for the coatings containing both the fluorochemical and polyoxyalkylene siloxane, and the water contact angle dropped significantly which contributes to improved soil resistance.

### Example 5

Coating composition samples were prepared according to the methods used in Example 1. The coating base of Paint #3 as listed in the Materials section, which is a semi-gloss low VOC paint, was used in this open-time test according to the Test Method 5. The results are in Table 6.

TABLE 6
Open-Time Extension with Coating Base Paint #3*

| Coating Base Combined with | |
|---|---|
| These Additive(s) | % Extension |
| None - Control | 0.0 |
| 0.067% Fluorochemical 2 + 0.033% | 3.1 |
| Polyoxyalkylene siloxane #1 | |
| 0.033% Fluorochemical 2 + 0.067% | 11.5 |
| Polyoxyalkylene siloxane #1 | |
| 0.02% Fluorochemical 2 + 0.08% | 10.0 |
| Polyoxyalkylene siloxane #1 | |
| 0.10% Polyoxyalkylene siloxane #1 | 7.9 |
| 0.10% Fluorochemical 2 | 8.8 |
| 0.05% Fluorochemical 2 | 10.0 |
| 0.05% Fluorochemical 2 + 0.025% | 3.0 |
| Polyoxyalkylene siloxane #1 | |
| 0.05% Fluorochemical 2 + 0.075% | 9.7 |
| Polyoxyalkylene siloxane #1 | |
| 0.05% Fluorochemical 2 + 0.125% | 16.7 |
| Polyoxyalkylene siloxane #1 | |
| 0.05% Fluorochemical 2 + 0.20% | 16.7 |
| Polyoxyalkylene siloxane #1 | |
| 0.10% Fluorochemical 2 + 0.025% | 10.3 |
| Polyoxyalkylene siloxane #1 | |
| 0.10% Fluorochemical 2 + 0.075% | 17.9 |
| Polyoxyalkylene siloxane #1 | |
| 0.10% Fluorochemical 2 + 0.125% | 8.6 |
| Polyoxyalkylene siloxane #1 | |
| 0.10% Fluorochemical 2 + 0.20% | 10.7 |
| Polyoxyalkylene siloxane #1 | |

*The percentages are based on weight of solid per wet paint.

The data in Table 6 demonstrates improvement in open time extension by addition of the polyoxyalkylene siloxane additive and the fluorochemical to a base coating.

### Example 6

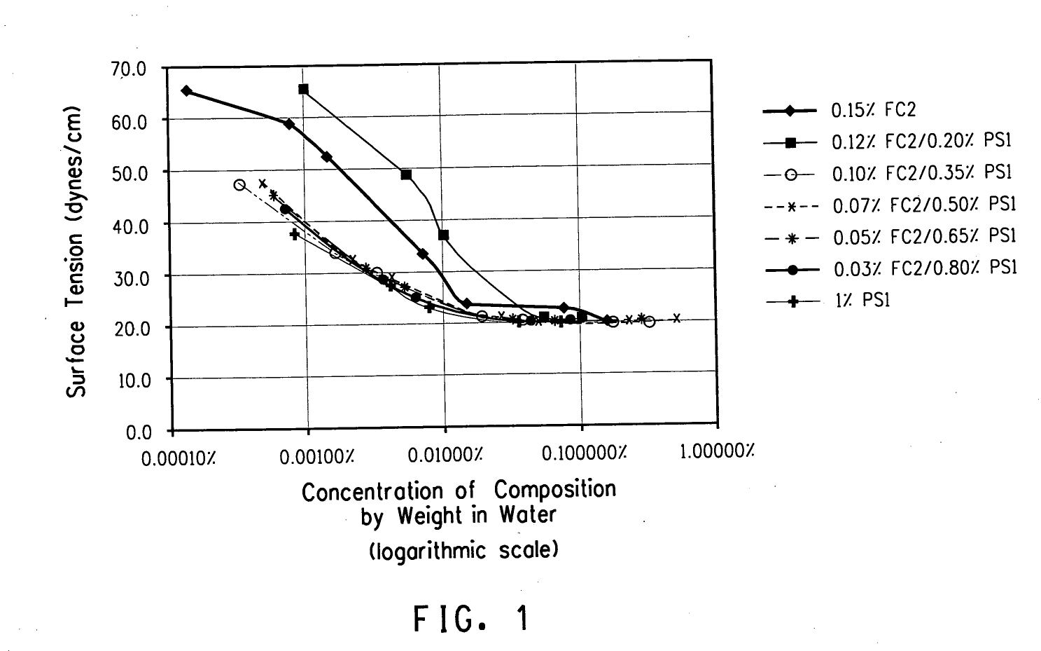

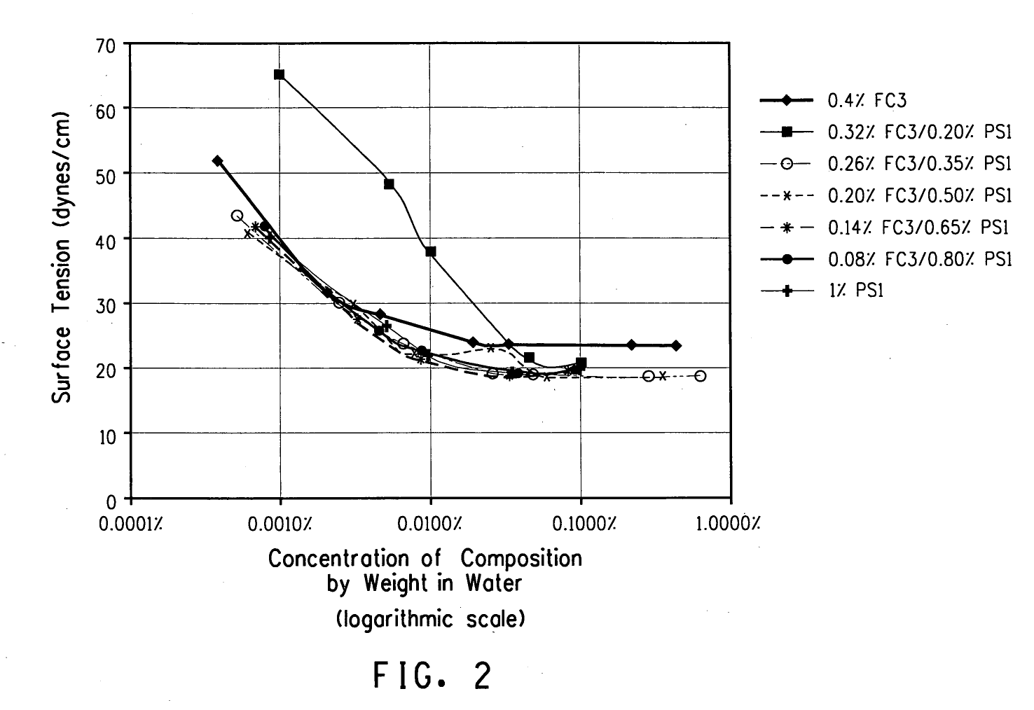

Fluorochemical 2, Polyoxyalkylene siloxane 1, and combinations thereof in the amounts shown in Table 7 were prepared as solutions by weight solids in water. The 1.0 g of sample indicated in Test Method 6 contained the amount of solid fluorochemical and/or polyoxyalkylene siloxane indicated in Table 7. These were diluted with water as described in Test Method 6 to provide solutions containing Total Solids as indicated in Table 7. These dilutions were tested for Surface Tension using Test Method 6. The resulting data are shown in FIG. 1 and Table 7. Fluorochemical 3, Polyoxyalkylene siloxane 1, and combinations thereof in the amounts shown in Table 8 were prepared as solutions by weight in water. The 1.0 g of sample indicated in Test Method 6 contained the amount of solid fluorochemical and/or polyoxyalkylene siloxane indicated in Table 8. These were diluted with water as described in Test Method 6 to provide solutions containing Total Solids as indicated in Table 8. These dilutions were tested for Surface Tension using Test Method 6. The resulting data are shown in FIG. 2 and Table 8.

TABLE 7

| Weight % of Solids in 1 g | Total Solids in | |
|---|---|---|
| of Sample | Diluted Solutions | Surface Tension: |
| 0.15% Fluorochemical 2 | 0.15 | 20.6 |
| | 0.075 | 22.6 |
| | 0.015 | 24.3 |
| | 0.0075 | 33.6 |
| | 0.0015 | 52.6 |
| | 0.00075 | 58.9 |
| | 0.00015 | 65.6 |
| 0.12% Fluorochemical | 0.32 | 19.5 |
| 2/0.20% | 0.16 | 19.6 |
| Polyoxyalkylene | 0.032 | 20.5 |
| siloxane 1 | 0.016 | 21.0 |
| | 0.0032 | 28.3 |
| | 0.0016 | 33.8 |
| | 0.00032 | 47.7 |
| 0.098% Fluorochemical | 0.448 | 19.7 |
| 2/0.35% | 0.224 | 19.8 |
| Polyoxyalkylene | 0.0448 | 20.0 |
| siloxane 1 | 0.0224 | 20.9 |
| | 0.00448 | 27.9 |
| | 0.00224 | 32.8 |
| | 0.000448 | 46.8 |
| 0.075% Fluorochemical | 0.575 | N/A |
| 2/0.50% | 0.2875 | 20.0 |
| Polyoxyalkylene | 0.0575 | 20.7 |
| siloxane 1 | 0.02875 | 20.8 |
| | 0.00575 | 26.0 |
| | 0.002875 | 30.2 |
| | 0.000575 | 43.8 |
| 0.053% Fluorochemical | 0.703 | N/A |
| 2/0.65% | 0.3515 | N/A |
| Polyoxyalkylene | 0.0703 | 20.5 |
| siloxane 1 | 0.03515 | 20.6 |
| | 0.00703 | 24.0 |
| | 0.003515 | 28.7 |
| | 0.000703 | 41.5 |
| 0.03% Fluorochemical | 0.83 | N/A |
| 2/0.80% | 0.415 | N/A |
| Polyoxyalkylene | 0.083 | 20.4 |
| siloxane 1 | 0.0415 | 20.6 |
| | 0.0083 | 22.5 |
| | 0.00415 | 27.0 |
| | 0.00083 | 37.2 |
| 1% Polyoxyalkylene | 1 | N/A |
| siloxane 1 | 0.5 | N/A |
| | 0.1 | 20.8 |
| | 0.05 | 21.0 |
| | 0.01 | 37.4 |
| | 0.005 | 48.3 |
| | 0.001 | 65.3 |

TABLE 8

| Weight % of Solids in 1 g of | Total Solids in | |
|---|---|---|
| Sample | Diluted Solutions | Surface Tension: |
| 0.4% Fluorochemical 3 | 0.4 | 22.8 |
| | 0.2 | 22.8 |
| | 0.04 | 22.9 |
| | 0.02 | 23.6 |
| | 0.004 | 28.3 |
| | 0.002 | 32.3 |
| | 0.0004 | 51.4 |
| 0.32% Fluorochemical | 0.52 | 18.6 |
| 3/0.20% Polyoxyalkylene | 0.26 | 18.6 |
| siloxane 1 | 0.052 | 18.9 |
| | 0.026 | 19.3 |
| | 0.0052 | 241 |
| | 0.0026 | 29.7 |
| | 0.00052 | 43.2 |
| 0.26% Fluorochemical | 0.61 | N/A |
| 3/0.35% Polyoxyalkylene | 0.305 | 18.7 |
| siloxane 1 | 0.061 | 18.7 |
| | 0.0305 | 22.6 |
| | 0.0061 | 22.9 |
| | 0.00305 | 29.4 |
| | 0.00061 | 40.7 |
| 0.20% Fluorochemical | 0.7 | N/A |
| 3/0.50% Polyoxyalkylene | 0.35 | N/A |
| siloxane 1 | 0.07 | 19.1 |
| | 0.035 | 19.1 |
| | 0.007 | 21.4 |
| | 0.0035 | 26.6 |
| | 0.0007 | 41.4 |
| 0.14% Fluorochemical | 0.79 | N/A |
| 3/0.65% Polyoxyalkylene | 0.395 | N/A |
| siloxane 1 | 0.079 | 19.3 |
| | 0.0395 | 19.4 |
| | 0.0079 | 22.8 |
| | 0.00395 | 26.3 |
| | 0.00079 | 41.3 |
| 0.08% Fluorochemical | 0.88 | N/A |
| 3/0.80% Polyoxyalkylene | 0.44 | N/A |
| siloxane 1 | 0.088 | 19.7 |
| | 0.044 | 19.7 |
| | 0.0088 | 22.3 |
| | 0.0044 | 26.8 |
| | 0.00088 | 39.8 |
| 1% Polyoxyalkylene | 1 | N/A |
| siloxane 1 | 0.5 | N/A |
| | 0.1 | 20.6 |
| | 0.05 | 21.0 |
| | 0.01 | 37.1 |
| | 0.005 | 48.6 |
| | 0.001 | 66.3 |

The surface tension data in Table 7 is graphed in FIG. 1, and is graphed in FIG. 2 in Table 8. FIGS. 1 and 2 show that a solution containing both the fluorochemical and the polyoxyalkylene siloxane had a lower surface tension than a solution containing either alone. A lower surface tension correlates with increased wetting and leveling in a coating composition containing the fluorochemical and polyoxyalkylene siloxane.

What is claimed is:

1. A composition comprising a coating base and a polyoxyalkylene siloxane additive and a fluorochemical.

2. The composition of claim 1 wherein the polyoxyalkylene siloxane additive is of Formulae 1A, 1B, 1C or 2.
(R²)₃SiO[Si(R²)₂O]_{y}[Si(R²)(R¹)O]ₓ[Si(R²)₂O]_{z}Si(R²)₃ Formula 1A
(R²)₃SiO[Si(R²)₂O]ₓ[Si(R²)₂R¹ Formula 1B
R¹(R²)₂SiO[Si(R²)₂O]ₓ[Si(R²)₂O]Si(R²)₂R¹ Formula 1C 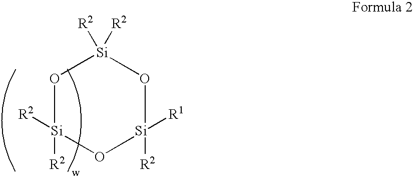
wherein
each R² is independently H, alkyl, or aryl;
each R¹ is a polyoxyalkylene group having the formula 3 as follows:
—Cₙ⁴ₚH₂ₙ₋ₚQCₘR⁵ₚH₂ₘ₋ₚOZR³ Formula 3
wherein
each R⁴ and R⁵ is independently H, alkyl, or aryl;
Q is CₙHR⁴, aryl, CH₂CH(OR⁴), CH₂(CH₂OR⁴), S, O, SO, SO₂, SO₂NR⁴, OC(O), OC(NR⁴), NHC(X) NH, or OC(X) NH or triazole;
Z is [C₂H₄O]ₐ and [C₃H₆O]_{b} in block or random order;
X is O or S;
m and n are each independently an integer of 2 to 8;
a is an integer of 0 to about 30; b is an integer of 0 to about 20;
provided that a+b is from 1 to about 50;
each R³ is independently H, acyl, CH₃, or a linear or branched alkyl or aryl group having 1 to about 20 carbon atoms;
w is an integer of from 1 to 3;
x is an integer of from 1 to about 20;
y is an integer of from 0 to about 20; and
z is an integer of from 0 to about 10.

3. The composition of claim 2 wherein R² is H, CH₃, C₂H₅ or C₆H₅.

4. The composition of claim 1 wherein the coating base is selected from the group consisting of an alkyd coating, urethane coating, unsaturated polyester coating, and a water dispersible coating.

5. The composition of claim 1 wherein the fluorochemical is selected from the group consisting of a perfluoroalkyl ester, fluorinated urethane, fluoroalkyl phosphate and salt thereof, fluoroalkyl phosphate ester, and fluoroalkylpolyoxyethylene and salt thereof.

6. The composition of claim 1 further comprising a titanium dioxide pigment.

7. The composition of claim 1 wherein the fluorochemical is Formula 4a, 4b, or 5 as follows:
R_{f}—X-A-OC—R, Formula 4a
R_{f}—X-A-OC—R_{X}—CO-A-X—R_{f}, Formula 4b 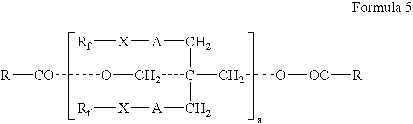
wherein:
R_{f} is a C₂-C₂₀ perfluoroalkyl radical or a C₅-C₃₈ perfluoroalkyl radical having at least one ether oxygen atom;
R is a C₃-C₂₄ unsaturated aliphatic hydrocarbon radical, a C₈-C₁₃ aryl radical having at least one non-aromatic double bond, or mixtures thereof;
X is independently —(CH₂)ₘ—, —CON(R₁)R₂—, —SO₂N(R₁)R₂—, or —(OCH₂CHR₃)_{b}O—, wherein m is 1 to about 20; b is 3 to about 15;
R₁ is H or an alkyl radical of 1 to about 4 carbon atoms, R₂ is C₁-C₁₂ alkylene, and R₃ is H or CH₂Cl;
A is O or S;
R_{X} is a divalent C₃-C₂₂ unsaturated aliphatic hydrocarbon radical, a divalent C₈-C₁₃ aryl radical having at least one non-aromatic double bond, or mixtures thereof; and
a is 1 or 2.

8. The composition of claim 5 wherein the fluorochemical is a polyfluorourethane compound which is the product of the reaction of (1) at least one diisocyanate, polyisocyanate, or mixture of polyisocyanates containing at least three isocyanate groups per molecule, (2) at least one fluorochemical compound containing at least one Zerewitinoff hydrogen in an amount sufficient to react with 5% to 80% of the isocyanate groups in the diisocyanate or polyisocyanate, (3) at least one compound of the formula R₁₀—(R₂)ₖ—YH in an amount sufficient to react with 5% to 80% of the isocyanate groups in the diisocyanate or polyisocyanate and wherein R₁₀ is a C₁-C₁₈ alkyl, C₁-C₁₈ omega-alkenyl radical, or C₁-C₁₈ omega-alkenoyl; R₂ is —CₙH₂ₙ— optionally end-capped by —[OCH₂C(R₄)H]ₚ—, —[OCH₂C(CH₂Cl)H]ₚ—, or —C(R₅)(R₆)(OCH₂C[CH₂Cl]H)ₚ— wherein R₄, R₅, and R₆ are the same or different and are H or a C₁-C₆ alkyl radical, n is 0 to 12, p is 1 to 50; Y is O, S, or N(R₇) wherein R₇ is H or C₁-C₆ alkyl; and k is 0 or 1, and (4) water in an amount sufficient to react with 5% to 60% of the isocyanate groups in the diisocyanate or polyisocyanate.

9. The composition of claim 1 wherein the fluorochemical is a fluoroalkylphosphate of Formula 6A or 6B 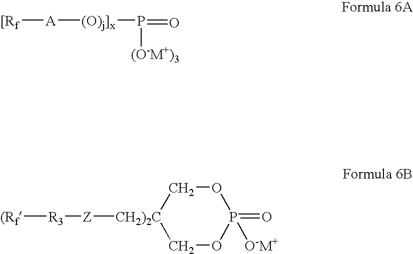
wherein:
R_{f} is F(CF₂CF₂)_{d}— or C₈F₁₇—,
A is (CH₂)ₐ, CH₂CH₂(OCH₂CH₂)_{b}, CH═CH(CH₂)_{c}, or A is SO₂N(R)CH₂CH₂ when R_{f} is C₈F₁₇—,
R_{f′} is a fluoroaliphatic group having a linear or branched perfluorocarbon chain having from 2 to 20 carbon atoms,
x is from about 1 to about 2,
j is 1 or 0 or a mixture thereof,
d is 1 to about 8, or a mixture thereof, and preferably is from about 3 to about 6,
M⁺ is an ammonium ion, an alkali metal ion, or an alkanolammonium ion, such as ethanolammonium or diethanolammonium, and preferably is ammonium, R is an alkylene group having from 1 to about 8 carbon atoms, and is preferably ethylene,
Z is —O—, —S—, or —NH—,
a is from about 2 to about 10,
b is from about 3 to about 20,
c is from about 2 to about 20, and
R is H or an aliphatic group containing 1 to about 4 carbon atoms.

10. The composition of claim 1 wherein the fluorochemical is a fluoroalkyl phosphate of Formula 7.
[CₘF₂ₘ₊₁CₙF₂ₙ—O]_{y}P(O)(OM)_{3-y} Formula 7
wherein
M is H, alkali metal ammonium, or NR¹R²R³ wherein each of R¹, R² and R³ are independently H, C₁ to C₂₀ alkyl, or C₁ to C₂₀ hydroxyalkyl,
m is an integer from 4 to 12,
n is an integer from 1 to 16,
y is a number of average value from 1.0 to 2.5,
provided that the two radicals Cₘ and Cₙ contain jointly a straight chain of not less than 8 carbon atoms.

11. The composition of claim 1 wherein the fluorochemical is a phosphate ester containing a perfluoroalkyl group, or mixtures and salts thereof.

12. The composition of claim 1 wherein the fluorochemical is a mixture of a fluoroalkyl phosphate and a glycol ester.

13. The composition of claim 1 wherein the fluorochemical is a fluoroalkyl polyoxyethylene.

14. The composition of claim 1 wherein the fluorochemical is perfluoroalkyl polyoxyethylene of Formula 8
R_{f}CₙH₂ₙQCₘH₂ₘ(C₂H₄O)ₗR Formula 8
wherein
n=1, 2, 4, 6;
m=0 to about 12;
l=5 about 15;
R_{f} is CₙF₂ₙ₊₁; (CF₃)₂CFOC₂F₄—; C₃F₇O[CF(CF₃)CF₂O)ₖCF₂—; C₃F₇O[CF(CF₃)CF₂O]ₖCF₂C(O)O—; or C₃F₇O[CF(CF₃)CF₂O]ₖCF₂CONH—;
k is 5 to 10;
Q is arylene, O, S, SO, SO₂;
R is H, CH₃, C₂H₅, or C(O)CH₃.

15. A dried or cured coating comprising the composition of claim 1.

16. A method of providing durable oil repellency and soil resistance to a surface having deposited thereon a dry coating composition comprising addition to the coating composition prior to drying a polyoxyalkylene siloxane and a fluorochemical selected from the group consisting of a perfluoroalkyl ester, fluorinated urethane, fluoroalkyl phosphate or salt thereof, fluoroalkyl phosphate ester or salt thereof, a mixture of a fluoroalkyl phosphate and glycol ester, and fluoroalkylpolyoxyethylene.

17. A method of providing durable cleanability to a surface having deposited thereon a dry coating composition comprising addition to the coating composition prior to drying a polyoxyalkylene siloxane and a fluorochemical selected from the group consisting of 1) fluorinated urethane, 2) fluoroalkyl phosphate and salt thereof, 3) fluoroalkyl phosphate ester and salt thereof, 4) a mixture of a fluoroalkyl phosphate and a glycol ester, and 5) fluoroalkylpolyoxyethylene.

18. A method of providing resistance to blocking to a surface having deposited thereon a dry coating composition comprising addition to the coating composition prior to drying a polyoxyalkylene siloxane and a fluorochemical selected from the group consisting of 1) fluoroalkyl phosphate and salt thereof, 2) fluoroalkyl phosphate ester and salt thereof, 3) a mixture of a fluoroalkyl phosphate and a glycol ester, and 4) fluoroalkylpolyoxyethylene.

19. A method of providing wetting, leveling and open time extension to a coating composition during application of the coating composition to the surface comprising addition to the coating composition prior to application of a polyoxyalkylene siloxane and a fluorochemical selected from the group consisting of a perfluoroalkyl ester, fluorinated urethane, fluoroalkyl phosphate or salt thereof, fluoroalkyl phosphate ester or salt thereof, a mixture of a fluoroalkyl phosphate and glycol ester, and fluoroalkylpolyoxyethylene.

20. The method of claim 15, 16, 17 or 18 wherein the polyoxylene siloxane is of Formulae 1A, 1B, 1C, or 2:
(R²)₃SiO[Si(R²)₂O]_{y}[Si(R²)(R¹)O]ₓ[Si(R²)₂O]_{z}Si(R²)₃ Formula 1A
(R²)₃SiO[Si(R²)₂O]ₓ[Si(R²)₂R¹ Formula 1B
R¹(R²)₂SiO[Si(R²)₂O]ₓ[Si(R²)₂O]Si(R²)₂R¹ Formula 1C 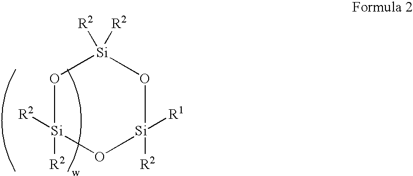
wherein
each R² is independently H, alkyl, or aryl;
each R¹ is a polyoxyalkylene group having the formula 3 as follows:
—CₙR⁴ₚH₂ₙ₋ₚQCₘR⁵ₚH₂ₘ₋ₚOZR³ Formula 3
wherein
each R⁴ and R⁵ is independently H, alkyl, or aryl;
Q is CₙHR⁴, aryl, CH₂CH(OR⁴), CH₂(CH₂OR⁴), S, O, SO, SO₂, SO₂NR⁴, OC(O), OC(NR⁴), NHC(X) NH, or OC(X) NH or triazole;
Z is [C₂H₄O]ₐ and [C₃H₆O]_{b} in block or random order;
X is O or S;
m and n are each independently an integer of 2 to 8;
a is an integer of 0 to about 30; b is an integer of 0 to about 20;
provided that a+b is from 1 to about 50;
each R³ is independently H, acyl, CH₃, or a linear or branched alkyl or aryl group having 1 to about 20 carbon atoms;
w is an integer of from 1 to 3;
x is an integer of from 1 to about 20;
y is an integer of from 0 to about 20; and
z is an integer of from 0 to about 10.
